(19) United States
(12) Patent Application Publication
(10) Pub. No.: US 2020/0097968 A1
(43) Pub. Date: Mar. 26, 2020

(54) SYSTEM AND LOGIC TO CONVERT AN EXISTING ONLINE BANK TRANSFER TRANSACTION

(71) Applicant: Visa International Service Association, San francisco, CA (US)

(72) Inventors: Rohit Sukhija, Bengaluru (IN); Jan Tore Klepp, Burlingame, CA (US); Palaniappan Kathiresan, Bangalore (IN); Vilas Hegde, Bangalore (IN)

(21) Appl. No.: 16/621,443

(22) PCT Filed: Jun. 14, 2017
(86) PCT No.: PCT/US2017/037541

§ 371 Date: Dec. 11, 2019

(51) Int. Cl. G06Q 20/40; G06Q 20/10; G06Q 20/38; G06F 9/54

(52) U.S. Cl. CPC G06Q 20/407; G06F 9/54; G06Q 20/3821; G06Q 20/108

(57) ABSTRACT

Embodiments of the disclosure discuss systems and methods for solving various issues associated with transaction schemes that have delayed (e.g., not real-time) transaction clearing. In particular, a first transaction between a user and a resource providing computer is processed under a first transaction scheme by having a user log into their account associated with an authorizing entity. The authorizing entity authenticates the user's account and provides an account identifier to a transaction guiding computer, which generates a reference to that first transaction to be stored along with first transaction details. The reference is shared with the resource providing computer. Subsequent transactions between the user and the resource providing computer can be processed under a second transaction scheme that utilizes the account identifier, which is retrieved using the reference to the first transaction. As a result, the first transaction is guaranteed to settle and any subsequent transactions are less risky since they are processed using saved details from the first transaction.

### FIELD

Methods and systems disclosed herein relate generally to facilitating transactions through various transaction schemes. More specifically, the methods and systems disclosed herein can be used to process and convert a transaction to a transaction scheme different from an initial transaction scheme used in an earlier transaction by using details from the earlier transaction.

### BACKGROUND

In today's technological environment, a user may interact with a variety of computer systems to initiate a transaction, which may include any exchange or interaction between two or more entities (e.g., between the user and a resource provider). The transaction can include the exchange of specific resources, goods, services, financial instruments, access (e.g., to a secure resource or area), and so forth. For example, on any given day, a user might interact with a first computer system to gain entry into a train terminal, a second computer system to access his or her office building, a third computer system to log onto his or her employer's network, and a fourth computer system to purchase coffee.

However, the contractual obligations in the transaction may not all occur simultaneously. For example, a user interacting with a computer system to purchase coffee may actually be exchanging a promise to pay for the coffee, since the user may receive the coffee before the transaction clears and the coffee vendor receives payment for the coffee. Clearing refers to all activities from the time a commitment is made for a transaction until it is settled and all the contractual obligations have been fulfilled. The clearing of a transaction may follow a transaction scheme, which can be any set of standard rules, protocols, or procedures that will dictate how funds are collected from the participants of the transaction. This clearing process may be performed by a transaction processor.

Some transaction schemes may require the user to provide an account number for an account associated with the user that contains the funds needed to settle the transaction. The clearing process will then turn the promise of payment (for example, in the form of a check or electronic payment request) into the actual movement of funds from the user's account to another account. Although such transaction schemes are convenient for users, they have numerous drawbacks. The success of the clearing process will depend on the validity of the account number, the validity of the account, the account having the funds needed to fulfill the contractual obligations, and the entity providing the account (e.g., an authorizing entity) will have to coordinate and accept instructions from the transaction processor performing the clearing. These transaction schemes are risky and prone to fraud since a user can provide a fraudulent account number or an account number for an account with insufficient funds. Alternatively, the user may mistakenly provide an incorrect account number or make an error when inputting the account number electronically. If the contractual obligations of the transaction are fulfilled asynchronously (e.g., the user receives a resource before settlement), then the user may receive the resource before the clearing process has identified any fraud or mistake.

At the same time, users may continue to prefer using these kinds of transaction schemes (as opposed to alternative transaction schemes that may address these issues) due to convenience and habit. Thus, there exists a need to remedy these issues in a manner that permits users to continue using these kinds of transaction schemes. Embodiments of the invention address this and other problems, individually and collectively.

### BRIEF SUMMARY OF THE INVENTION

In some embodiments, a computer-implemented method is contemplated that involves receiving, by a transaction guiding computer, a request from a client computer to process a transaction through an existing online account managed by an authorizing entity. The transaction guiding computer may direct a user of the client computer to supply a set of credentials to the authorizing entity, wherein the set of credentials is associated with the existing online account managed by the authorizing entity. The transaction guiding computer may receive a confirmation from a transaction processor computer indicating the supplied set of credentials is valid, wherein the confirmation further includes details for the transaction and an account identifier associated with the online account. The transaction guiding computer may determine a reference to the transaction. The transaction guiding computer may store the account identifier along with details for the transaction and the reference to the transaction in a transaction database. The transaction guiding computer may send the reference to the transaction to the client computer.

In some embodiments, the transaction guiding computer receives confirmation from the transaction processor computer through an API call. The transaction guiding computer may receive a subsequent request from the client computer to process a subsequent transaction, wherein the subsequent request includes the reference to the transaction. The transaction guiding computer may retrieve the account identifier from the transaction database using the reference to the transaction. The account identifier is then used to process the subsequent transaction.

In some embodiments, a computer-implemented method is contemplated that involves sending, by a client computer, a request to a transaction guiding computer to process a transaction through an existing online account managed by an authorizing entity. The client computer may receive instructions for a user of the client computer to supply a set of credentials to the authorizing entity, wherein the set of credentials is associated with the existing online account managed by the authorizing entity. The client computer may receive a confirmation from the transaction guiding computer indicating the supplied set of credentials is valid, wherein the confirmation further includes a reference to the transaction. The client computer may store the reference to the transaction in a transaction reference database.

In some embodiments, the client computer may store an identifier for the user along with the reference to the transaction in the transaction reference database. The client computer may receive an initiation of a subsequent transaction with the user. The client computer may retrieve the reference to the transaction from the transaction reference database using the identifier for the user. The client computer may send a subsequent request to the transaction guiding computer to process the subsequent transaction, wherein the subsequent request includes the reference to the transaction.

In some embodiments, a computer-implemented method is contemplated that involves receiving, by a transaction guiding computer, a request from a client computer to refund a transaction processed through an existing online account managed by an authorizing entity, wherein the request includes a reference to the transaction and a refund amount. The transaction guiding computer may retrieve an account identifier along with details for the transaction from a transaction databased based on the reference to the transaction, wherein the details for the transaction include a payment amount. The transaction guiding computer may determine that the refund amount does not exceed the payment amount. The transaction guiding computer may determine a transaction processor computer for refunding the transaction. The transaction guiding computer may send the refund request to the transaction processor computer along with the account identifier.

In some embodiments, the account identifier may be an account number. In some embodiments, the supplied set of credentials includes a username and a password. In some embodiments, the account identifier stored in the transaction database is encrypted. In some embodiments, the client computer is operated by a resource providing entity. In some embodiments, the details for the transaction include a payment amount for the transaction.

### BRIEF DESCRIPTION OF THE DRAWINGS

FIG. 1 is a system diagram for a system usable to convert transactions between transaction schemes, in accordance with embodiments of the present disclosure.

FIG. 2 is a component diagram of a resource providing computer, in accordance with embodiments of the present disclosure.

FIG. 3 is a block diagram of a transaction guiding computer, in accordance with embodiments of the present disclosure.

FIG. 4 is a flow diagram for performing a transaction through a first transaction scheme, in accordance with embodiments of the present disclosure.

FIG. 5 is a flow diagram for creating a mandate, in accordance with embodiments of the present disclosure.

FIG. 6 is a flow diagram for performing a transaction through a second transaction scheme, in accordance with embodiments of the present disclosure.

FIG. 7 illustrates a flow diagram for refunding a transaction conducted through a first transaction scheme, in accordance with embodiments of the present disclosure.

### DETAILED DESCRIPTION OF THE INVENTION

Introduction

As previously discussed, some transactions are conducted and cleared using transaction schemes that require the user to provide an account number for an account associated with the user that is used to settle the transaction. The clearing process will then turn a promise of payment (for example, in the form of a check or electronic payment request) into the actual movement of funds from the user's account to another account. Some examples of these transaction schemes include Automated Clearing House (ACH) and the use of bank-issued checks.

Another example is the Single Euro Payments Area (SEPA) direct debit transaction scheme (referred to herein as “SEPA DD”) that is popular in Europe. SEPA DD is an important transaction scheme in many European markets and countries and commands about 30% of the total payment volume in those markets. For simplicity and facilitating ease of understanding, this disclosure makes frequent reference to the SEPA DD transaction scheme. However, any aspect of this disclosure may be used in conjunction with any similar transaction schemes.

In the SEPA DD transaction scheme, the user (e.g., consumer) may initiate a transaction with a resource providing computer of a resource provider (e.g., merchants of goods or services). As part of the transaction, the user may provide to the resource providing computer some account details (e.g., an account number) for the user's account that is provided by an authorizing entity (e.g., a bank). In particular, the user may provide an International Bank Account Number (IBAN) associated with their account. The resource providing computer may share those account details and details of the transaction with a transaction processor, which will in turn share the account details with that authorizing entity. The authorizing entity uses those details to pull money from the user's account and settle the transaction. Many resource providers continue to offer to users (e.g., consumers) the option of conducting transactions using the SEPA DD transaction scheme, and it remains one of the top transaction methods used by consumers in Europe due to habit and convenience.

However, there are numerous risks and drawbacks associated with the SEPA DD transaction scheme. For example, the resource provider may need to obtain a signed mandate from the user and lodge it with the authorizing entity in order for the user's account to be debited. Otherwise, a user may easily reverse or refund the transaction by reaching out to the authorizing entity, which will request the signed mandate from the resource provider as proof for validating the transaction. In the case that the mandate was signed, the user has 8 weeks to request the reversal, otherwise the user still has 13 months to request the reversal.

Additionally, in contrast to credit cards, the SEPA DD transaction scheme does not utilize a model of authentication for better confirmation of ring-fencing of the funds. Ring-fencing of funds involves a credit card issuing authority (e.g., Chase) receiving an Authorization API request, and the credit card issuing authority checks the credit capability of the consumer and confirms that the transaction request has been authorized. In this example, if the consumer has a credit limit of 100 USD and the authorization was for 50 USD, 50 USD would be set apart for that payment. In other words, the funds are ring-fenced by the issuer but not yet transferred to the merchant's bank account. If another authorization request of 70 USD is received, it may be rejected by the issuer since 50 USD out of the 100 USD limit has already been set apart for the earlier payment. Eventually, the ring-fenced funds (e.g., 50 USD) are either set free due to an authorization reversal request or are transferred to the merchant's bank account using a capture/settlement request. Further in comparison to credit cards, the SEPA DD transaction scheme does not provide standard reconciliation and files as with credit card networks.

Furthermore, it can take a few days for the authorizing entity to credit the payment to the resource provider's account. In that time, the user may have already obtained a resource from the resource provider without the resource provider receiving the payment or even a guarantee of payment. There is a chance that the resource provider will not receive any payment at all, as evidenced by the high rate of transactions through SEPA DD in which money is not debited from a user's account or transferred to a resource provider's account. One reason for this is that the SEPA DD transaction scheme requires a lot of conditions to be fulfilled in order for the transaction to successfully clear. The success of the clearing process will depend on the validity of the account number, the validity of the account, the account having the funds needed to fulfill the contractual obligations, and the entity providing the account (e.g., an authorizing entity) will have to coordinate and accept instructions from the transaction processor performing the clearing. In many cases, the transaction will fail due to problems associated with the account number or the user's account. For example, the account number (e.g., IBAN) shared by the user may be wrong or invalid. This can be unintentional (e.g., a mistake made in inputting the account number electronically) or it can be intentional (e.g., in the case of fraud, where the user provides a fraudulent account number). Additionally, the account itself may lack the resources or credentials (e.g., security clearance) necessary to settle the transaction, which can result in failure of the clearing process and the user's account not being debited.

From a resource provider's perspective, transactions through SEPA DD are quite risky due to these drawbacks. These risks are not shouldered by the users, who highly demand the payment method. As a result, resource providers are forced to make hard decisions regarding offering transactions through SEPA DD by balancing consumer demand and the necessity of reducing non-payment risk. For resource providers dealing in goods, conducting transactions through SEPA DD increases overhead for managing inventory and can lead to decreased sales, as there is a risk in sending goods to the user before settlement (e.g., the users provide a fake account number and receive their goods before the transaction has been cleared).

Various solutions have been proposed for reducing the risks to resource providers that are inherent in the SEPA DD transaction scheme. For example, some resource providers obtain signed mandates for every transaction. As another example, some resource providers collect the user's address for address verification. As another example, some resource providers or transaction processors run the user provided account number (e.g., the IBAN) through a whitelist/blacklist to see if that account number has been previously blocked due to fraud. However, these methods are not safe and only reduce friendly fraud (e.g., an unintentional mistake by the user) since they are easily circumvented by a determined fraudster. Some resource providers or transaction processors (e.g., PayPal) have resorted to making small fund transfers in the user's account for verification purposes. Two small deposits will be made in the user's account, such as a deposit of 5 cents and a deposit of 3 cents. That total amount (e.g., 8 cents) will then be withdrawn from the user's account. The user will then be prompted to verify the individual amounts of the two deposits. However, this method requires that the user wait for the deposits to be made before the user can transact with the resource provider.

Thus, even with these proposed solutions, the resource providers continue to face difficult decisions regarding the offering of transactions through SEPA DD. Resource providers that allow SEPA DD transactions subject themselves to losses due to the high fraud rate, or if the resource providers decide to wait until the transaction clears before providing the resource (e.g., wait 5 days for the funds to appear in their account before sending out goods) there will be reduced consumer satisfaction among the users who are forced to wait. Resource providers that choose not to offer SEPA DD transactions due to the high risk may face a loss of business and revenue since the consumers have a preference for transactions through SEPA DD.

The various embodiments of the present disclosure address these problems, and more, by converting a transaction (e.g., between a user and a resource provider) to a transaction scheme different from an initial transaction scheme used in an earlier transaction (also conducted between that user and resource provider) by using details associated with the earlier transaction. In other words, transactions conducted through a first transaction scheme are used as the basis for transactions conducted through a second transaction scheme that is different from the first transaction scheme. In some embodiments, this is accomplished through a transaction guiding computer that is in communication with multiple transaction processors that operate under various transaction schemes. The transaction guiding computer is specifically positioned to handle communication between the resource providing computer of the resource provider and those transaction processors.

In some embodiments, the user will initiate a first transaction with a resource providing computer through a first transaction scheme. The resource providing computer will send a transaction request to the transaction guiding computer indicating the first transaction will be performed using the first transaction scheme. The user will be directed to a portal (e.g., a website) associated with the authorizing entity that allows the user to provide account details (e.g., username, credentials) associated with their account provided by that authorizing entity. In other words, the user will immediately authenticate their account with the authorizing entity. The authorizing entity will immediately validate the user's account and the transaction guiding computer will be notified of the user's account number and that the user's account has been successfully validated. The transaction guiding computer will generate a reference to the first transaction and save that reference along with details of the first transaction (including the user's account number), while providing the reference to the resource providing computer. The resource providing computer can save that reference for future use, such as for a second transaction between the user and the resource providing computer through a second transaction scheme that utilizes the user's account number.

For the second transaction, the resource providing computer can retrieve the saved reference for the first transaction and send it along with a transaction request to the transaction guiding computer. The transaction guiding computer can then use the reference to retrieve details of the first transaction and the user's account number that was obtained during the course of the first transaction. That user's account number can then be used to clear the second transaction using the second transaction scheme (e.g., by sending it to a transaction processor configured to use the second transaction scheme).

In some embodiments, the first transaction scheme will be an online bank transfer (OBT) transaction scheme. Under the OBT scheme, a user can log in to their bank account and authorize a payment to ensure a guaranteed payment for the resource provider. Examples of such transaction processors utilizing the OBT transaction scheme in Europe include iDEAL, giropay, and so forth. The OBT transaction scheme may allow transactions to be cleared in real-time or close to real-time unlike through SEPA DD, which may take a few days. These types of OBT schemes are valuable to resource providers since they offer guaranteed payments. The second transaction scheme may be a SEPA DD transaction scheme. Thus, a first transaction between a user and a resource provider is conducted through OBT. Details from that first transaction, including the user's account number (e.g., IBAN), are used to seamlessly facilitate a second transaction conducted through SEPA DD. In particular, the user's account number shared in the first transaction is used to set up a SEPA DD transaction request and instructions for debiting the user's account.

However, such embodiments face the issue of OBT schemes commonly lacking the ability to refund an OBT transaction. For example, OBT schemes such as giropay, iDeal, and EPS do not offer a way of refunding payment. This creates customer management issues for resource providers since they have to find alternate ways to refund users. Accordingly, the embodiments disclosed herein also address this problem by allowing for refunds to be processed through a different transaction scheme, such as the SEPA DD transaction scheme. In particular, the transaction guiding computer is configured to receive and check refund requests by forwarding them to the appropriate transaction processor.

Terms and Definitions

Prior to discussing the details of some embodiments of the present invention, description of some terms may be helpful in understanding the various embodiments.

A “transaction” may comprise any exchange or interaction between two or more entities. The transaction can include the exchange of resources, goods, services, financial instruments, access (e.g., to a secure resource or area), and so forth. In some embodiments, the transaction may include the exchange of an asset or service in return for payment between a buyer or seller, The transaction may include a “clearing” process, which denotes all activities from the time a commitment is made for a transaction until the transaction is settled (e.g., the delivery and fulfillment of contractual obligations). Clearing a transaction may involve processes for turning the promise of payment (for example, in the form of a check or electronic payment request) into the actual movement of money from one account to another.

A “transaction scheme” may comprise any standard defining a set of standard rules, protocols, or procedures used in conducting a transaction. In some embodiments, a transaction scheme may be a standard used in clearing a transaction and collecting funds from the participants of the transaction. Some examples of transaction schemes include Online Bank Transfer (OBT), SEPA Direct Debit (SDD), Automated Clearing House Debit (ACH), and so forth.

“SEPA Direct Debit” (SEPA DD) may refer to an interbank transaction scheme defining a common set of rules and standard procedures for direct debits and the collection of funds (e.g., between a debtor and creditor) in Europe. SEPA DD allows direct debits to be made from any domestic account to any receiver within the 34 participating countries. Under the SEPA DD transaction scheme, a mandate may be completed and signed by the debtor (e.g., the customer) to authorize the creditor to collect payments via SEPA DD and the debtor's authorizing entity to pay those collections.

“Online Bank Transfer” may refer to any interbank transaction scheme that allows users to conduct transactions by accessing their account provided by an authorizing entity using an online portal (e.g., a website). While logged into their user account through the portal, a user may be able to directly authorize a payment transfer with the authorizing entity.

A “resource provider” may comprise any entity that can provide a specific resource, good, service, financial instrument, or access. Examples of a resource provider include merchants, game companies, data providers such as government agencies, etc. In some cases, a resource provider may possess or be associated with a “resource providing computer”, which may be configured to interact with users in order to carry out a transaction. In some embodiments, a resource provider may be a “merchant”, which may typically be an entity that engages in transactions and can sell goods or services.

A “processor” may refer to any suitable data computation device or devices. A processor may comprise one or more microprocessors working together to accomplish a desired function. The processor may include CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

An “application” may be computer code or other data stored on a computer readable medium (e.g. memory element or secure element) that may be executable by a processor to complete a task.

A “transaction request” may be an electronic message that is sent to request processing of a transaction. The transaction request may include details associated with the transaction, such as any information associated with a current transaction, an identification of a good or service, a transaction amount, a merchant identifier, a merchant location, etc., as well as any other information that may be utilized in the processing of a transaction.

An “API message” may be a formatted message that facilitates communications between system components according to an application programming interface or API. The API message may allow system components to share data and initiate actions on each other's behalf. For example, an API message may comprise transaction data that may initiate a server computer to return a response based on the transaction data.

An “application programming interface” or “API” may be a set of routines, protocols, and tools that specify how system components should interact. The API may allow various components of a system to generate, send, and receive to and from each other in a recognizable format. The API may be preconfigured, installed, or programmed onto a device, and may instruct the device to perform specified operations and networking commands. The API may allow for the request of services by initiating calls to specific instructions or code stored in an application.

A “credential” may be any suitable information that serves as reliable evidence of worth, ownership, identity, or authority. A credential may be a string of numbers, letters, or any other suitable characters, as well as any object or document that can serve as confirmation. Examples of credentials include value credentials, identification cards, certified documents, access cards, passcodes and other login information, etc.

A “reference” may be any uniquely generated value usable for retrieving data from a database that is linked or associated with that reference. The reference may be a string of numbers, letters, or any other suitable characters. In some embodiments, a reference may be shared and transferred between system components to initiate, authorize, settle, or resolve a transaction, or to represent an original credential (e.g., an account identifier) in instances where the original credential would typically be provided. In some embodiments, a reference may be generated in a manner such that the recovery of the original credential from the reference value may not be computationally derived. Further, in some embodiments, the reference format may be configured to allow the entity receiving the reference to identify it as a reference and recognize the entity that issued the reference. In some cases, the reference may be a transaction reference that is associated with a particular transaction or details of that transaction. In some cases, the reference may be a mandate reference that is associated with a particular mandate or details of that mandate.

An “authorizing entity” may be an entity that authorizes a request. Examples of an authorizing entity may be an issuer, a governmental agency, a document repository, an access administrator, etc. An authorizing entity may operate an authorization computer. An “issuer” may refer to a business entity (e.g., a bank) that issues and optionally maintains an account for a user. An issuer may also issue payment credentials stored on a user device, such as a cellular telephone, smart card, tablet, or laptop to the consumer.

An “account identifier” may include an identifier for an account. An account identifier may include an original account identifier associated with a payment account. The account identifier may be in any suitable form and may include any suitable types of characters. Examples of account identifiers include account numbers, tokens, verification values such as CVVs, etc. For example, an account identifier may be an international bank account number (IBAN).

A “resource provider identifier” can include any suitable type of information that can identify a resource provider or a location of a resource provider. Examples of resource provider identifiers may include a software ID, merchant ID, a store ID, a device ID of a device at a resource provider location, etc.

Figures

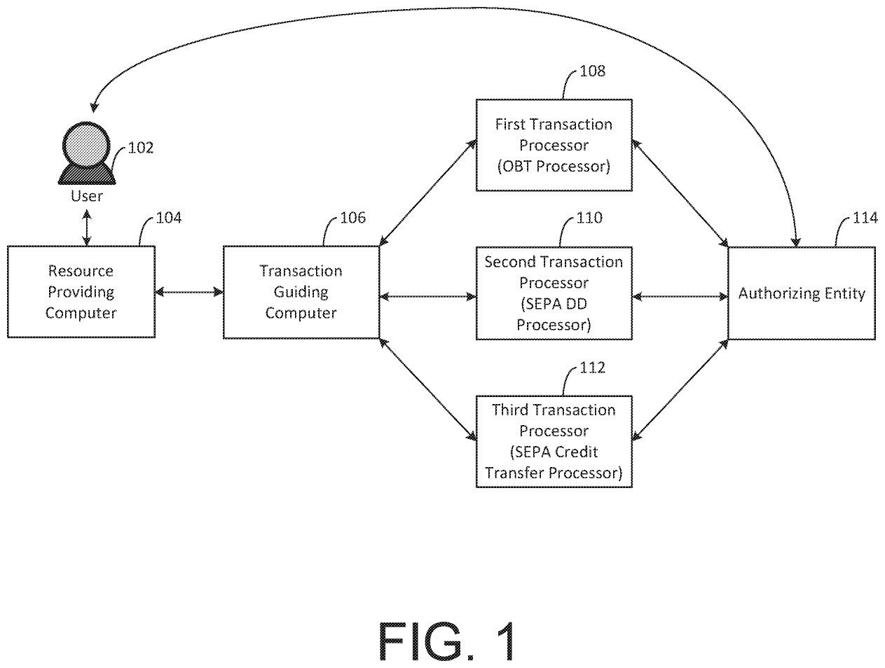

FIG. 1 is a system diagram for a system usable to convert transactions between transaction schemes, in accordance with embodiments of the present disclosure. In some embodiments like the one shown in the figure, the system may include a user 102, a resource providing computer 104, a transaction guiding computer 106, one or more transaction processors (which may include a first transaction processor 108, a second transaction processor 110, and/or a third transaction processor 112), and an authorizing entity 114.

In order to help facilitate an understanding of the roles of the components in the system, the embodiment presented in the figure has been simplified. In various embodiments, the authorizing entity 114 may correspond to multiple authorizing entities (e.g., the system may include one or more authorizing entities). In various embodiments, there may be any number of transaction processors and they may be different from the three shown in the figure.

In some embodiments, the user 102 may be able to initiate a transaction with the resource providing computer 104 of a resource provider. For example, the user 102 may be seeking access to a secure resource, or the user may be looking to make a purchase of an item or service. This can be done in various ways. For example, the resource providing computer 104 may have or be in communication with an access device that has a display screen and an input mechanism (e.g., a touchscreen or a keyboard/keypad). Or, the user 102 may have a computing device (e.g., a computer or mobile device) that is configured to communicate and interface with the resource providing computer 104 in order to initiate the transaction.

In some embodiments, the resource providing computer 104 may be communicatively coupled to a transaction guiding computer 106. In some embodiments, the transaction guiding computer 106 may be communicatively coupled to multiple transaction processors (e.g., first transaction processor 108, second transaction processor 110, third transaction processor 112, and so forth) that follow various transaction schemes. The transaction guiding computer 106 may have a separate connection with each transaction processor, which allows the transaction guiding computer 106 to take in information from the first transaction processor 108 and share information with the second transaction processor 110. The transaction guiding computer 106 may be uniquely positioned between the resource providing computer 104 and the various transaction processors, which allows the transaction guiding computer 106 to communicate with both the resource providing computer 104 and the transaction processors. This allows the transaction guiding computer 106 to facilitate transactions through various transaction schemes by receiving transaction requests from the resource providing computer 104 and selecting the transaction processor with the appropriate transaction scheme for clearing the transaction.

In some embodiments (not shown), the transaction guiding computer 106 may also be communicatively coupled to the authorizing entity 114, such that the transaction guiding computer 106 may be able to directly communicate with the authorizing entity 114 without having to communicate through one of the transaction processors.

In some embodiments, each of the transaction processors may be communicatively coupled to the authorizing entity 114. In some embodiments, the first transaction processor 108 may be a transaction processor that utilizes an online banking transfer (OBT) transaction scheme. In some of such embodiments, the first transaction processor 108 may be referred to as an OBT processor. In some embodiments (not shown), the transaction guiding computer 106 may be in communication with multiple transaction processors that follow the first transaction scheme.

In some embodiments, the second transaction processor 110 may be a transaction processor that utilizes a SEPA direct debit (SEPA DD) transaction scheme. In some of such embodiments, the second transaction processor 110 may be referred to as a SEPA DD processor. In some embodiments (not shown), the transaction guiding computer 106 may be in communication with multiple transaction processors that follow the second transaction scheme.

In some embodiments, the third transaction processor 112 may be a transaction processor that utilizes a SEPA credit transfer transaction scheme. In some of such embodiments, the third transaction processor 112 may be referred to as a SEPA credit transfer processor. The SEPA credit transfer processor may be used to facilitate the reversal or refunding of transactions. In some embodiments (not shown), the transaction guiding computer 106 may be in communication with multiple transaction processors that follow the third transaction scheme.

In some embodiments, there may be multiple transaction processors that are connected to the same authorizing entity (e.g., the same funding source). However, the transaction processors may connect to that authorizing entity in various ways depending on the characteristics of each transaction processor's transaction scheme.

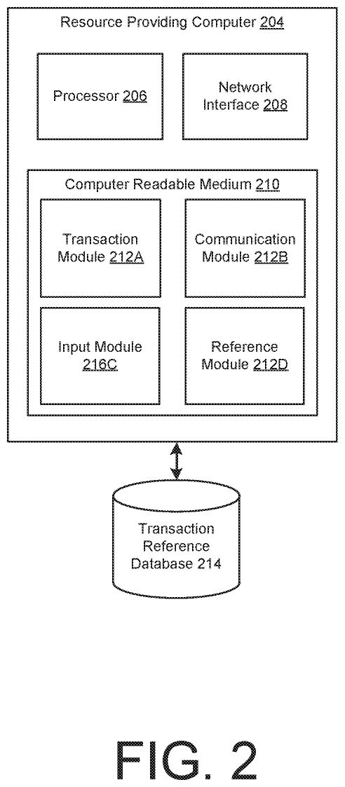

FIG. 2 is a component diagram of a resource providing computer, in accordance with embodiments of the present disclosure.

The resource providing computer 204 may be any computer, device, or server computer configured to initiate transactions between a resource provider and a user, such as the resource providing computer 104 of FIG. 1.

In some embodiments, the resource providing computer 204 may comprise a processor 206 (or multiple processors) for executing instructions or logic, a network interface 208 for sending and receiving messages over a network, and computer readable medium 210 for storing instructions or modules that may be executed by processor 206 to perform tasks and methods according to embodiments of the invention. The instructions or modules may be in the form of code stored in an application or of an application programming interface (API).

In some embodiments, the computer readable medium 210 may comprise transaction module 212A for instructing processor 206 to generate or collect transaction data comprising information about a transaction (e.g. transaction amount, credentials associated with the user initiating the transaction, the products or services involved in the transaction, and so forth). In one embodiment, the transaction data may also comprise a transaction timestamp specifying the time and date of the transaction, as well as a transaction ID which may be recorded and later be used to identify the transaction that takes place.

In some embodiments, the computer readable medium 210 may further comprise communication module 212B for instructing processor 206 to receive, format, and transmit data and/or messages over network interface 208. For example, communication module 212B may comprise code for formatting and sending to a transaction request to a transaction guiding computer. In some embodiments, the communication module 212B may be used to facilitate communications between the resource providing computer 104 and the transaction guiding computer 106 shown in FIG. 1, by formatting the communication into an interpretable form for transaction processing computer 106. In some embodiments, the transaction request sent to the transaction guiding computer may comprise the transaction data, the desired transaction scheme for the transaction, a resource provider identifier of a resource provider, and so forth. The resource provider identifier may be a merchant ID identifying the resource provider or resource providing computer that generated the transaction request and may also be associated with a resource provider category or merchant category code. A category code may be a code designated to specific resource providing computer systems that share similar characteristics. For example, a merchant category code (MCC) may be equal to ‘4112,’ which may indicate that resource providing computer belongs to a category of computer systems that share the characteristics of, or have been designated as, ‘passenger railways.’

In some embodiments, the computer readable medium 210 may further comprise input module 212C for instructing processor 206 to collect information from the user used in the transaction. For example, the resource providing computer 204 may be paired with an access device having a display and input components (e.g., a keyboard or keypad) that allows the user to provide inputs related to the transaction. Or the resource providing computer 204 may be paired with the user's computing device and the input module 212C may receive information that the user provides through their computing device.

In some embodiments, the computer readable medium 210 may further comprise reference module 212D for receiving references to transactions and storing them in the transaction reference database 214 that is coupled to the resource providing computer 204. These references may be generated by the transaction guiding computer.

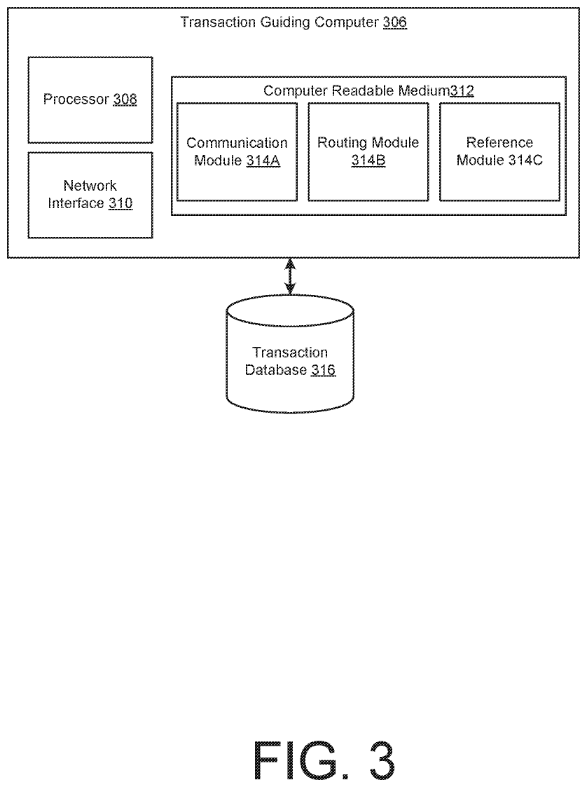

FIG. 3 shows a block diagram of a transaction guiding computer, in accordance with embodiments of the present disclosure. The transaction guiding computer 306 may be any processing computer or server computer configured to receive transaction requests and communicate with transaction processors to clear those transactions, such as the transaction guiding computer 106 of FIG. 1. The transaction guiding computer 306 may comprise a processor 308 for executing instructions or logic, a network interface 310 for sending and receiving messages over a network, and computer readable medium 312 for storing modules or code that may be used to initiate or perform tasks upon execution by processor 308.

In some embodiments, the computer readable medium 312 may comprise communication module 314A for instructing processor 308 to receive, format, and transmit data and/or messages over network interface 310. For example, communication module 314A may comprise code for receiving and transmitting messages (e.g., a transaction request) from a resource providing computer, a transaction processor (e.g., a modified and forwarded transaction request), and/or an authorizing entity. In some instances, communication module 314A may comprise code instructing transaction guiding computer 306 to receive and reformat transaction messages that are communicatively exchanged through network interface 542. In some embodiments, the communication module 314A may format transaction requests depending on the transaction processor used and the transaction scheme associated with that transaction processor. In some embodiments, the transaction request forwarded to the transaction processor may comprise the transaction data, a resource provider identifier of a resource provider, and so forth.

In some embodiments, the communication module 314A may further comprise code for identifying an authorizing entity based on at least the details of an account used in a transaction (e.g., an account identifier or number). For example, an account identifier may be an IBAN and the transaction guiding computer 306 may determine that the account number corresponds to a specific authorizing entity. Thus, the communication module 314A may dictate which authorizing entity the transaction guiding computer 306 will communicate with regarding the transaction.

In some embodiments, the computer readable medium 312 may comprise routing module 314B for instructing processor 308 to select an appropriate transaction processor for clearing a transaction based on the desired transaction scheme or transaction processor indicated in the transaction request sent by the resource providing computer. For example, the resource providing computer may send an API call to the transaction guiding computer 306 indicating that the transaction is to be processed using a second transaction scheme. The routing module 314B may determine a specific transaction processor that follows the second transaction scheme to route the transaction request to.

In some embodiments, the computer readable medium 312 may comprise reference module 314C for instructing processor 308 to generate a reference for a transaction, and to store or retrieve the reference in the transaction database 316. A transaction reference may be a unique string of numbers, letters, or any other suitable characters.

In some embodiments, the transaction guiding computer 306 may be coupled to a transaction database 316 that holds details of transactions and references to those transactions. In some embodiments, the contents of the transaction database 316 may be searchable, such that a reference to a particular transaction can be used to look up all the saved details associated with that transaction. In some embodiments, the contents of the transaction database 316 may be encrypted. For example, user account numbers (e.g., their IBANs) may be encrypted and stored in the transaction database 316.

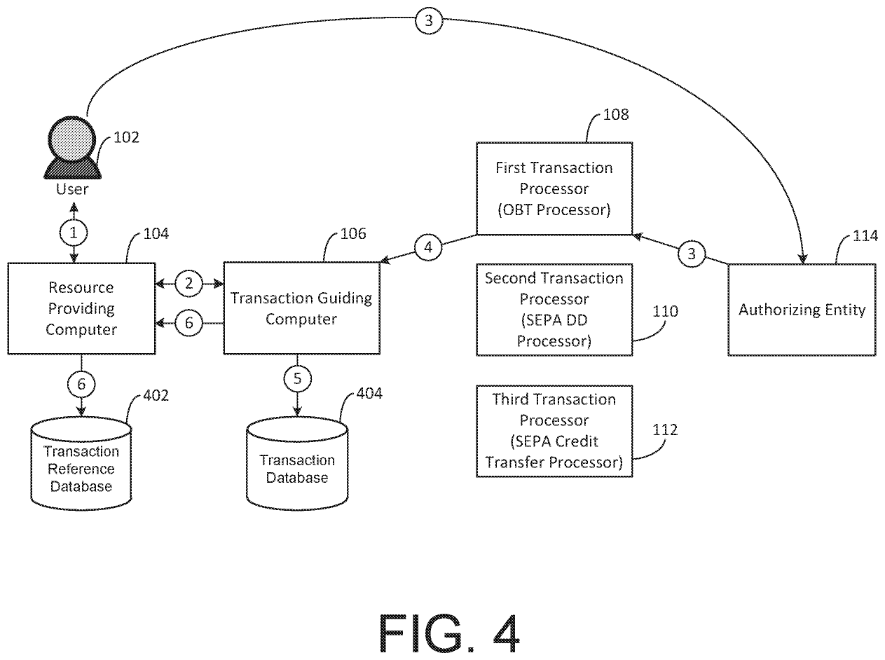

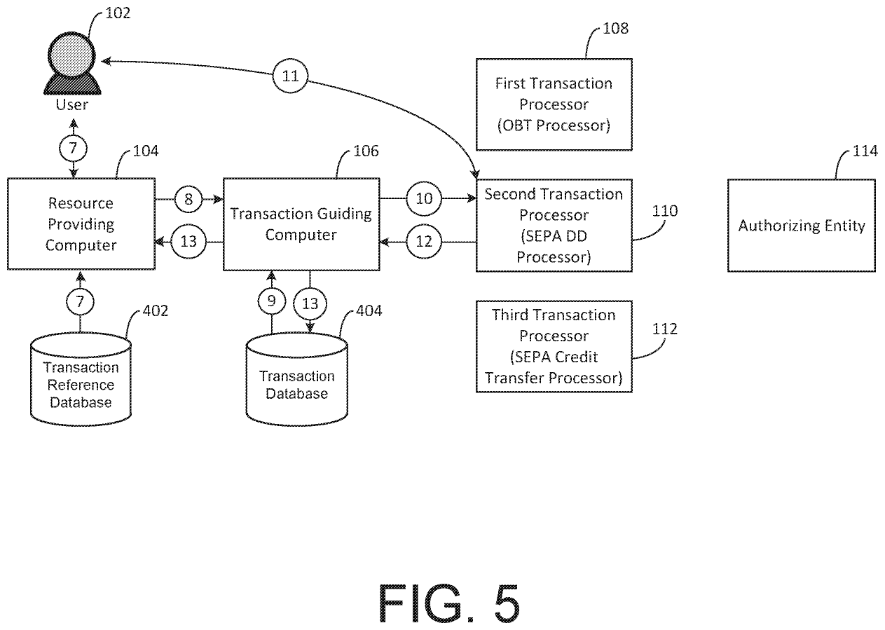

FIG. 4 illustrates a flow diagram for performing a transaction through a first transaction scheme, in accordance with embodiments of the present disclosure. In particular, the figure depicts a first transaction initiated between a user 102 and a resource providing computer 104 that is performed using the first transaction scheme. The processing of that first transaction may include the transaction guiding computer 106 saving details associated with that first transaction to be used in subsequent transactions (not shown). FIG. 4 may be better understood in connection with FIGS. 5-7.

At step 1, a user 102 may attempt to initiate a transaction with a resource providing computer 104 of a resource provider. For instance, the user 102 may initiate the transaction through an access device or input device associated with the resource providing computer 104, or the user 102 may initiate the transaction through a computing device or mobile device that is in communication with the resource providing computer 104 (e.g., via an application running on their computing device or mobile device). In some embodiments, the user 102 may provide details of the transaction (e.g., the items being exchanged, or the payment amount involved) to the resource providing computer 104.

In some embodiments, the resource providing computer 104 may offer various transaction clearing options to the user 102. Among the options offered to the user 102 may be an option that the transaction be cleared via a first transaction scheme (e.g., online bank transfer) utilized by the first transaction processor 108. In embodiments, the first transaction scheme is an online bank transfer (OBT) transaction scheme, and the resource providing computer 104 may offer OBT as a transaction method or clearing mechanism to the user 102. The steps in FIG. 4 continue to illustrate what happens if the user 102 decides to clear the transaction via the first transaction scheme.

At step 2, once the user 102 has chosen to transact using the first transaction scheme, the resource providing computer 104 may send the transaction guiding computer 106 an API request (e.g., a transaction request) to clear the transaction (e.g., process the payment) through the first transaction scheme (e.g, through OBT). Examples of such OBT transaction schemes in Europe may include iDeal, giropay, Sofort, and so forth. In some embodiments, once the transaction guiding computer 106 receives and accepts the transaction request, the transaction guiding computer 106 may notify the resource providing computer 104 to direct the user 102 to an electronic portal associated with the authorizing entity 114. In some embodiments, at step 1 the user 102 may specify the authorizing entity 114 (e.g., by selecting it among a set of authorizing entities) or the user 102 may provide information that can be used by the transaction guiding computer 106 to determine the appropriate authorizing entity 114.

At step 3, the user 102 may be taken to an electronic portal associated with the authorizing entity 114 in order for the user 102 to log into their account provided to them by the authorizing entity 114, such as by entering account information (e.g., credentials) for their account into the portal. For example, in some embodiments, the user 102 may have an existing account with the authorizing entity 114 that is accessible electronically, and that account may be associated with an account number (e.g., IBAN), a username, and a password. The resource providing computer 104 may access a web portal or website for the authorizing entity 114 and display it on a display component of the resource providing computer 104 for the user 102 to see. The user 102 can then log into their account by entering details (e.g., the username and password) for their account (e.g., a set of credentials including a username and password, and/or the user's account number) into the portal using an input component of the resource providing computer 104. Alternatively, the resource providing computer 104 could direct a computing device or mobile device in possession of the user 102 to access the web portal or website for the authorizing entity 114, and the user 102 would log into their account through that device rather than through the resource providing computer 104.

In either case, once the user 102 provides account details to the authorizing entity 114, the authorizing entity 114 can authenticate the user-provided details. In some embodiments, if the authorizing entity 114 successfully authenticates the user's account then the authorizing entity 114 will automatically authorize the transaction (e.g., by authorizing payment from the user's account or enabling the transfer of funds from the user's account). In some embodiments, once the authorizing entity 114 authenticates the user's account, the user 102 may have to confirm the payment as an extra step. For instance, the user 102 may have to indicate to the authorizing entity 114 that the transaction is confirmed by pressing additional buttons through the resource providing computer 104 and/or the user's computing device.

In some embodiments (not shown), the authorizing entity 114 may directly notify the transaction guiding computer 106 that the user 102 has successfully logged into their account with the authorizing entity 114 and has confirmed the payment. The authorizing entity 114 may also inform the transaction guiding computer 106 of certain details associated with the authenticated user's account, such as the user's account number (e.g., the IBAN). In other embodiments, the authorizing entity 114 may instead notify the first transaction processor 108 (e.g., an OBT processor) that the user 102 has successfully logged into their account and confirmed the payment. The authorizing entity 114 may also inform the first transaction processor 108 of certain details associated with the authenticated user's account, such as the account number (e.g., the IBAN). Then, at step 4, the first transaction processor 108 may inform the transaction guiding computer 106 that the user 102 has successfully logged into their account and has confirmed the payment. The first transaction processor 108 may also send details associated with the user's account, such as the account number, to the transaction guiding computer 106.

In some embodiments, the information received by the transaction guiding computer 106 is pushed to the transaction guiding computer 106 (e.g., by the authorizing entity 114 and/or the first transaction processor 108). For example, the information is sent to the transaction guiding computer 106 through an automated notification (e.g., a webhook notification) to notify the transaction guiding computer 106 that the user 102 successfully logged in. In some embodiments, the transaction guiding computer 106 pulls the necessary information (e.g., from the authorizing entity 114 and/or the first transaction processor 108). For example, the information may be sent in response to an API call that the transaction guiding computer 106 makes against that transaction to the first transaction processor 108 and/or the authorizing entity 114.

At step 5, once the transaction guiding computer 106 receives details for the user's account that was successfully authenticated by the authorizing entity 114, the transaction guiding computer 106 may generate a reference (e.g., a transaction reference) to the current transaction (e.g., the first transaction) involving the user's account. The reference may be any unique identifier, string, token, and so forth, that allows details for the current transaction to be referenced and retrieved at a later time. For example, the transaction guiding computer 106 could generate a reference using random numbers and letters. The transaction guiding computer 106 may then store the reference and the details for the transaction in the transaction database 404. The stored details may include user account details and the user's account number (e.g., the IBAN) used in the transaction, and they may be linked to the reference so that the reference by itself can be used to retrieve those details from the transaction database 404. In some embodiments, some or all of the transaction details may be encrypted and stored in the transaction database 404. For example, the IBAN for a user could be encrypted before it is stored in the transaction database 404.

At step 6, the transaction guiding computer 106 may send the generated reference to the resource providing computer 104. This may notify the resource providing computer 106 that the user's account has been successfully authenticated and enabled for use in the first transaction (e.g., for the OBT payment). Although in some embodiments the transaction guiding computer 106 could also send the user's account number (e.g., the IBAN) to the resource providing computer 104, preferably the user's account number is not sent along with the reference to the resource providing computer 104 so that the secrecy of the account number is preserved with the transaction guiding computer 106. Once the resource providing computer 104 receives the reference, it may save the reference in the transaction reference database 402 for future use. In some embodiments, the saved reference may be linked with details associated with the first transaction. For example, the reference may be associated with a user number or user identity (not to be confused with the user's account for the authorizing entity 114) assigned to the user 102 by the resource providing computer 104. This user number or user identity assigned to each user may allow the resource providing computer 104 to look up and retrieve references associated with past transactions for a user. For instance, in a second transaction between the resource providing computer 104 and the user 102, the resource providing computer 104 may determine the user identity and look up all references associated with that user identity in order to determine that the user 102 was involved in a previous transaction cleared through the first transaction scheme. In some embodiments, the transaction guiding computer 106 may send the user's account number (e.g., IBAN) or account identifier to the resource providing computer 104 rather than the reference.

In summary, a user may be able perform a first transaction by logging into their user account associated with the authorizing entity and authorizing the transaction via the OBT transaction scheme. Since the user authorizes the payment directly through the authorizing entity at the time of the first transaction, the payment will be successful. Furthermore, the transaction guiding computer 106 receives a user account number that is always legitimate because it is received (directly or indirectly) from the authorizing entity 114. The account number will also be correct since it is not input manually by the user (e.g., through the textbox of a user interface displayed by the resource providing computer 104 or the user's mobile device). Furthermore, the frequency of fraud is reduced since the user logs into their account to confirm the transaction, which means that the user owns that account and it has not been stolen. Additionally, as depicted in FIG. 5, the user's account details can also be used to generate a mandate for future transactions conducted with a different transaction scheme (such as SEPA DD) so that the resource provider has proof that the user provided permission to debit funds from their account.

FIG. 5 illustrates a flow diagram for creating a mandate, in accordance with embodiments of the present disclosure. A mandate serves as a receipt or legally binding proof that a user gave permission for debiting their user account (e.g., with the authorizing entity) in connection with a transaction. Mandates can be generated, signed, and saved using an e-mandate process. In the context of SEPA DD transactions, a SEPA mandate is provided by a resource provider to be completed by the user (e.g., customer) to authorize the resource provider to collect payments via the SEPA Direct Debit transaction scheme. The SEPA mandate includes the authorization of the authorizing entity to pay these collections. This figure depicts how the transaction guiding computer 106 can be used to facilitate the creation of a mandate through an e-mandate process. In particular, the resource providing computer 104 may send a mandate request along with a reference to the first transaction to the transaction guiding computer 106, which will use that reference in order to retrieve the user's account number to be used for the mandate. FIG. 5 may be better understood in connection with FIG. 4, since in some embodiments, the sequence of events in FIG. 5 occurs after the sequence of events in FIG. 4.

At step 7, the resource providing computer 104 may determine that the user 102 was involved in an earlier transaction (e.g., the first transaction performed using the first transaction scheme). In some embodiments, the resource providing computer 104 may determine this by using the user number or user identity associated with the user 102 to look up if there are any references associated with that user stored in the transaction reference database 402. Once it is determined that a reference for an earlier transaction with the user is available, the resource providing computer 104 may offer to the user 102 the option of converting the details from the first transaction (e.g., the OBT transaction) to be used for instructions for a second transaction cleared through a second transaction scheme (e.g., SEPA direct debit instructions). For example, the resource providing computer 104 may display that option through a display component of the resource providing computer 104 or the option may be presented on a computing device or mobile device belonging to the user 102. If the user 102 agrees to converting transaction details for use in a second transaction scheme, then the resource providing computer 104 may retrieve the saved reference of the first transaction from the transaction reference database 402.

At step 8, the resource providing computer 104 may send a mandate creation request to the transaction guiding computer 106, along with the retrieved reference of the first transaction (e.g., the reference to the original OBT payment depicted in FIG. 4).

At step 9, the transaction guiding computer 106 may receive the mandate creation request and the reference. The transaction guiding computer 106 may use the reference to look up details of the first transaction in the transaction database 404. The details of the first transaction may include user account details, such as the user account number (e.g., the IBAN) used in the first transaction. Accordingly, the transaction guiding computer 106 may use the reference to fetch the account number for user 102 from the transaction database 404.

At step 10, the transaction guiding computer 106 may route the mandate creation request along with the user account number to the second transaction processor 110, which is a different transaction processor than the first transaction processor 108. The second transaction processor 110 may follow a second transaction scheme (e.g., SEPA DD) that is different from the first transaction scheme. In some embodiments, the second transaction processor 110 may be a SEPA DD processor, whereas the first transaction processor 108 may be an OBT processor. Thus, the second transaction processor 110 will receive the user's account number which was retrieved by the transaction guiding computer 106 using a reference generated from the first transaction.

At step 11, once the second transaction processor 110 receives the user's account number, the second transaction processor 110 may direct the user 102 to an e-mandate signing page. This can be done in a variety of ways. For example, the link to the e-mandate signing page could be sent back to the resource providing computer 104 to be displayed on a display component of the resource providing computer 104. Or, the link to the e-mandate signing page could be sent to the user's computing or mobile device. In either case, the user 102 will be presented with the e-mandate signing page where the user's account number (e.g., the IBAN) will be displayed but locked from editing by the user 102. The user 102 may sign the e-mandate against that IBAN (e.g., by providing a signature). In some embodiments, the user 102 may have to enter some additional information, such as their phone number, during the signing of the e-mandate. In some embodiments, a one-time password may be sent to the user-provided phone number and the user 102 may have to enter the received password to confirm that the user 102 is granting permission for their account to be debited by the resource provider.

In some embodiments, once the e-mandate has been signed, the second transaction processor 110 may generate a reference (e.g., a mandate reference) to the signed e-mandate. Like the references generated by the transaction guiding computer 106, this reference may be any unique identifier, string, token, and so forth, that allows a saved e-mandate to be referenced and retrieved at a later time. For example, the second transaction processor 110 may generate a reference using random numbers and letters. The second transaction processor 110 may then store a copy of the signed e-mandate along with the generated reference, which can be used at a later time to retrieve the signed e-mandate. The saved copy of the signed e-mandate can be logged for later disputes that may arise between the user 102 and the resource provider.

At step 12, the second transaction processor 110 may send the mandate reference for the signed e-mandate to the transaction guiding computer 106. This may confirm to the transaction guiding computer 106 that the mandate creation request was fulfilled, or a separate confirmation may be sent by the second transaction processor 110.

At step 13, the transaction guiding computer 106 may store the mandate reference in the transaction database 404 (or a different database). In some embodiments, the mandate reference will be stored with the transaction reference or other account details associated with the user 102, such that the mandate reference can be retrieved by the transaction guiding computer 106 using a transaction reference. The transaction guiding computer 106 may also send the mandate reference to the resource providing computer 104 to use for future transactions performed using the second transaction scheme (e.g., SEPA DD). In some embodiments, the transaction guiding computer 106 may also send a confirmation to the resource providing computer 104 indicating that the SEPA DD mandate has been signed by the user 102.

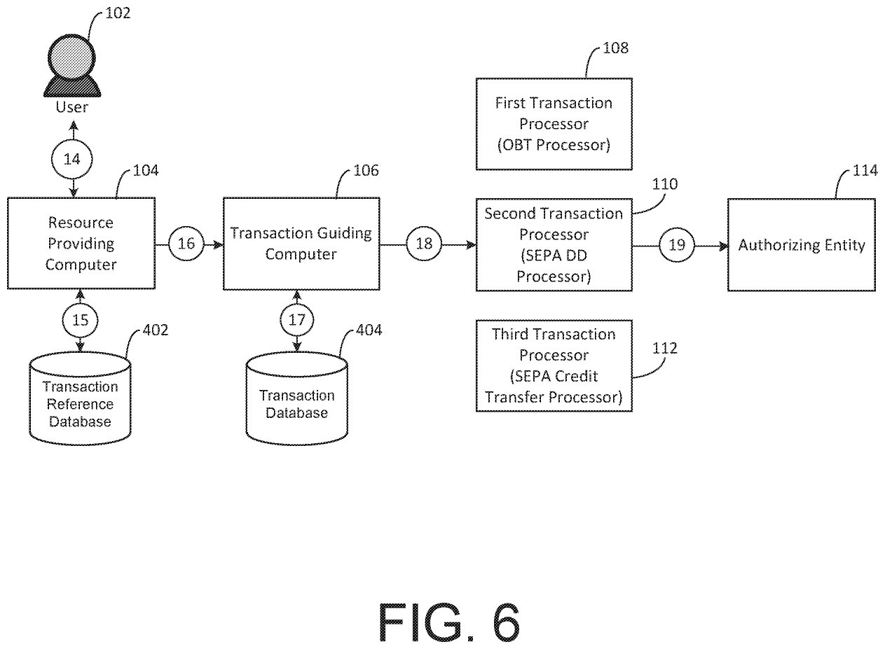

In summary, the transaction guiding computer 106 uses the reference for a first transaction to fetch details from that first transaction, such as the account number for the user 102. The account number is sent to the second transaction processor 110 for use in the generation of an e-mandate, which is presented to the user 102 to be signed by the user 102. A mandate reference is generated and stored with the signed e-mandate. The mandate reference is then sent to the transaction guiding computer 106, which can forward it to the resource providing computer 104 for future use. Thus as depicted in FIG. 6, at a later point in time, the resource providing computer 104 can send transaction requests for a second transaction through a second transaction scheme (e.g., SEPA DD) against the signed mandate, which permits the user's account used to make the first transaction (e.g., the original OBT payment) to be debited in the course of the second transaction.

FIG. 6 illustrates a flow diagram for performing a transaction through a second transaction scheme, in accordance with embodiments of the present disclosure. In particular, the figure depicts a second transaction initiated between a user 102 and a resource providing computer 104 that is performed using the second transaction scheme. The processing of that second transaction may include the transaction guiding computer 106 retrieving details associated with a first transaction to be used in clearing the second transaction. FIG. 4 may be better understood in connection with FIGS. 5-7. FIG. 6 may be better understood in connection with FIGS. 4 and 5, since in some embodiments, the sequence of events in FIG. 6 occurs after the sequence of events in FIG. 5.

At step 14, the user 102 and the resource providing computer 104 may engage in a second transaction. The resource providing computer 104 may determine that it has previously conducted a first transaction with the user 102. In some embodiments, the resource providing computer 104 may determine this by checking a user number or user identifier associated with the user 102 against the available transaction references in the transaction reference database 402. If the user 102 had conducted a first transaction through a first transaction scheme, then the reference to that first transaction should be saved in the transaction reference database 402 and retrievable for that user 102. If a first transaction using the first transaction scheme was conducted with the user 102, the resource providing computer 104 may offer to the user 102 the option to conduct the second transaction via the second transaction scheme (e.g., SEPA DD). This option may be presented for the user's selection via a display component of the resource providing computer 104, or it may be presented on the user's computing or mobile device that is in communication with the resource providing computer 104.

At step 15, if the user 102 chooses to clear the second transaction via the second transaction scheme, then the resource providing computer 104 may access the transaction reference database 402 in order to obtain the reference to the first transaction for that user 102.

At step 16, the resource providing computer 104 will submit a transaction request (e.g., an API request) to the transaction guiding computer 106 to clear the second transaction (e.g., process the payment) through the second transaction scheme (e.g., SEPA DD). This transaction request will include details for the second transaction (e.g., the amount of the transaction, the resource provider's identifier or account identifier, and so forth). In some embodiments, the transaction request may include the transaction reference for the first transaction (e.g., retrieved from the transaction reference database 402), while in other embodiments, the transaction reference may be sent separately from the transaction request.

At step 17, the transaction guiding computer 106 may use the reference to retrieve the details for the first transaction (e.g., including the account number the user 102 used in the first transaction) from the transaction database 404. In some embodiments, the transaction guiding computer 106 may do this by matching the reference received from the resource providing computer 104 against the references within the transaction database 404. Since the transaction guiding computer 106 generated the reference saved by the resource providing computer 104, there should be a match. Details of the first transaction should be referenced and retrievable from the transaction database 404 using the transaction reference.

At step 18, the transaction guiding computer 106 may send the transaction request, along with the account number (e.g., the IBAN) used in the first transaction, to the second transaction processor 110 for clearing the second transaction via the second transaction scheme. The second transaction processor 110 determines from the transaction request the terms of the transaction, including the amount of payment and the resource provider's account identifier. Thus, the second transaction processor knows a source account from the user's account number, a destination account from the resource provider's account identifier, and the amount of funds to transfer between the accounts.

At step 19, the second transaction processor 110 coordinates with the authorizing entity 114 to clear the second transaction in typical fashion under the SEPA DD transaction scheme. The authorizing entity 114 takes funds from the user's account and deposits them into the resource provider's account.

In summary, the resource providing computer 104 retrieves the reference stored from the first transaction and sends it to the transaction guiding computer 106, which uses that reference to retrieve the account number for the user that was used in the first transaction. The transaction guiding computer 106 allows a second transaction to be performed over a second transaction scheme using the account number from the first transaction. The transaction guiding computer 106 sends the account number and details of the second transaction to the second transaction processor 110 to clear the second transaction using the second transaction scheme. Notably, the transaction guiding computer 106 uses the information received from one transaction processor to send a transaction request to another transaction processor, making this a seamless process for the resource provider.

This approach may be particularly useful for resource providers which provide resources to users on a subscription model (e.g., providing a good or service every six-month months). Once a new user signs up for the subscription, the first transaction between the resource provider and the user can be used to verify the user's account and guarantee that the first transaction will clear (e.g., by processing the payment through OBT). Subsequent transactions between that user and the resource provider can be conducted using a different transaction scheme without worrying about fraud since the user's account has already been verified and utilized in the first transaction.

In some embodiments, the user 102 may have to repeatedly renew the subscription. Each time a payment is to be made under the subscription model, the resource providing computer 104 may ask the user 102 if the payment can be made using the user's account used in the first transaction. If the user 102 agrees, then the resource providing computer 104 may send a mandate request to the transaction guiding computer 106 that includes the reference to the first transaction conducted using the first transaction scheme.

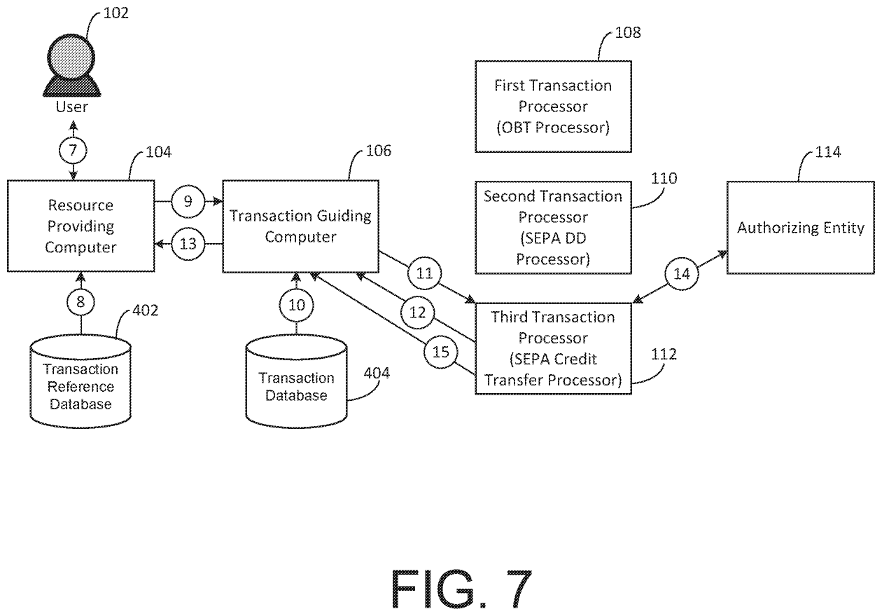

FIG. 7 illustrates a flow diagram for refunding a transaction conducted through a first transaction scheme, in accordance with embodiments of the present disclosure. In particular, the figure depicts how the second transaction scheme may be used to provide a refund if the first transaction scheme does not directly permit refunds. FIG. 7 may be better understood in connection with FIG. 4, since in some embodiments, the sequence of events in FIG. 7 occurs after the sequence of events in FIG. 4.

At step 7, the user 102 may wish to initiate a refund for the first transaction (e.g., cleared through the OBT transaction scheme) by notifying the resource providing computer 104. In some embodiments, this refund can be initiated through the user's computing or mobile device, which will notify the resource providing computer 104.

At step 8, the resource providing computer 104 may retrieve the reference to the first transaction from the transaction reference database 402. In some embodiments, the reference may be saved under a user identifier associated with the user 102 and the resource providing computer 104 may be able to look up that reference through the user identifier.

At step 9, the resource providing computer 104 may send a refund request for the first transaction (e.g., the OBT payment) to the transaction guiding computer 106. The refund request may include the retrieved reference to the first transaction, or the refund request may be sent along with the reference to the first transaction.

At step 10, the transaction guiding computer 106 receives the refund request and may determine that the refund request is for a transaction that was cleared using a first transaction scheme (e.g., an OBT payment), for which the first transaction processor 108 does not directly support refunds. Upon this determination, the transaction guiding computer 106 may retrieve the details of the first transaction from the transaction database 404 using the reference in order to obtain the user's account number (e.g., the IBAN). In some embodiments, the transaction guiding computer 106 may check the refund request against the details of the first transaction. For example, the transaction guiding computer 106 may check to see if the refund amount being requested is more or less than the payment in the first transaction. If the refund amount is more than the payment in the first transaction, then the transaction guiding computer 106 may reject the refund request and notify the resource providing computer 104.

At step 11, the transaction guiding computer 106 may use the user account number and the details of the first transaction to send a refund request (e.g., a SEPA Credit Transfer request) to a third transaction processor 112 (e.g., a SEPA Credit Transfer Processor) that is configured to process a credit to the user 102's account using that information. In some embodiments, the third transaction processor 112 follows a third transaction scheme. The refund request may indicate how much payment to refund to the user's account identified by the account number.

At step 12, the third transaction processor 112 may respond to the transaction guiding computer 106 indicating that the refund request has been accepted by the third transaction processor 112.

At step 13, the transaction guiding computer 106 forwards that information to the resource providing computer 104 indicating that the refund request has been accepted. In turn, the resource providing computer 104 may inform the user 102.

At step 14, the third transaction processor 112 my coordinate with the authorizing entity 114 to refund the first transaction, such as by crediting the user's account and debiting the account of the resource provider (e.g., the counterparty in the first transaction or the owner of the resource providing computer 104). In some embodiments, the first transaction may be refunded a few days after the user's initial request for a refund.

At step 15, the third transaction processor 112 may notify the transaction guiding computer 106 that the refund was successful. In some embodiments, this notification is pushed to the transaction guiding computer 106. For example, the notification can be sent to the transaction guiding computer 106 through an automated notification (e.g., a webhook notification) that the refund was successful. In some embodiments, the transaction guiding computer 106 may pull this status information. For example, the transaction guiding computer 106 may use a status check API to check the status of that refund after a few days.

Alternatively, in some embodiments, once the transaction guiding computer 106 determines that the first transaction processor 108 does not directly support refunds, the transaction guiding computer 106 may send the refund request to the second transaction processor 110 to refund the user 102 (e.g., through the SEPA DD transaction scheme).

Additional Benefits

The systems and methods disclosed herein provide numerous benefits in terms of convenience, data security, and data input accuracy.

In particular, the system provides convenience for resource providers by reducing the risks of fraud associated with SEPA DD transactions since the user accounts are authenticated by the authorizing entity. Additionally, it also reduces the risk of refunds to SEPA DD transactions beyond 8 weeks since a signed e-mandate is obtained using the same user account number for the first transaction. As a result, resource providers can release goods or services to users immediately rather than having to wait days for transactions to clear. The first transaction is guaranteed and any subsequent transactions also carry less risk since they are performed using the same user account as was used in the first transaction. Furthermore, the system allows for the ability to retry SEPA DD transactions at a later time in case the user's account has insufficient funds.

The system also provides a way of refunding OBT transactions without having to request from a user their account number, which in some cases can be long is not memorized by most consumers. The refund can be processed through various transaction schemes based on the original transaction with that user's account. The specific transaction scheme used can be selected by the transaction guiding computer based on the capabilities of the transaction processors, and the transaction guiding computer will route the transaction request without the resource provider needing to furnish account numbers or transaction details.

The system also provides an extra layer of data security when clearing transactions. First, the transaction details are all stored by the transaction guiding computer, which may have one or more software or hardware security modules dedicated to securing that information and storing it in the transaction database. The transaction guiding computer may also encrypt some or all of the contents stored in the transaction database. For example, the transaction guiding computer could encrypt transaction details such as user account numbers before saving them to the transaction database. Second, those transaction details are not shared with the resource providing computer. A reference to a particular transaction is generated and shared with the resource providing computer. By itself, the reference is meaningless. Thus, if the resource providing computer is compromised or the communications between the resource providing computer and transaction guiding computer are compromised, no valuable information can be obtained in the security breach. Thus, resource providers do not have to worry about storing original transaction identifiers or user account numbers, which would be a potential security issue. Third, the user has to log into their account with the authorizing entity in order to conduct a first transaction using the first transaction scheme. This provides additional authentication of the user's account and confirms the user's intent to transaction using that account.

The system also provides an improvement to the accuracy of data entry. In today's technological environment, a user may have to electronically input their account number through keys, dials, switches, touchscreens, and so forth, to be used for processing a transaction through a SEPA DD transaction scheme. This is not only cumbersome but it is prone to user input errors and wrong account numbers. For instance, the input device may be a set of keys that are closely arranged. The user may mistakenly press a key that neighbors the key the user intended to press. The inaccuracy in data entry that arises when converting physical user inputs into electronic data is a problem that is rooted in computer technology. The contemplated embodiments of this disclosure specifically overcome this problem arising in the realm of computer inputs by removing the need for the user to manually supply an account number. The account number is never entered by the user. Instead, the user must log in to their account only once in order for the account number to be received by the transaction guiding computer, which can save that information to be used in future transactions that do not require the user to log in or supply additional information by way of manual inputs. This removes the possibility of the user providing a wrong account number or the account number belong to someone else.

Alternative Embodiments

The contemplated embodiments of this disclosure are not limited to clearing transactions by settling payments and can be adapted for any suitable purpose. For instance, it can be used in connection with credit checks performed for a user. The user or a third-party may enlist a resource providing computer to perform a credit check for the user. Instead of the user providing confidential details associated with themselves (e.g., a social security number, credit card numbers, etc.) to the resource providing computer and/or the third party, the user may be directed to an online portal with an authorizing entity. The user may provide credentials (e.g., username and password) that allows the authorizing entity to authenticate the identity of the user (e.g., the user is a particular individual). Any confidential information associated with the user can then be transmitted by the authorizing entity to the transaction guiding computer to be used in the credit check. A reference to that credit check can be generated and shared with the resource providing computer. In any future credit checks conducted by the resource providing computer for the user, the reference can be used by the transaction guiding computer to look up the original credit check for the user and to obtain any confidential details associated it. Thus, subsequent credit checks can be performed for the user without the user having to directly furnish confidential information and the resource providing computer never has knowledge of that confidential information.

Additional Implementation Details

Specific details regarding some of the above-described aspects are provided above. The specific details of the specific aspects may be combined in any suitable manner without departing from the spirit and scope of embodiments of the invention.

It should be understood that the present invention as described above can be implemented in the form of control logic using computer software (stored in a tangible physical medium) in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A computer-implemented method comprising:
receiving, by a transaction guiding computer, a request from a client computer to process a transaction through an existing online account managed by an authorizing entity;
directing, by the transaction guiding computer, a user of the client computer to supply a set of credentials to the authorizing entity, wherein the set of credentials is associated with the existing online account managed by the authorizing entity;
receiving, by the transaction guiding computer, a confirmation from a transaction processor computer indicating the supplied set of credentials is valid, wherein the confirmation further includes details for the transaction and an account identifier associated with the online account;
determining, by the transaction guiding computer, a reference to the transaction;
storing, by the transaction guiding computer, the account identifier along with details for the transaction and the reference to the transaction in a transaction database; and
sending, by the transaction guiding computer, the reference to the transaction to the client computer.

2. The method of claim 1, wherein the account identifier is an account number.

3. The method of claim 1, wherein the supplied set of credentials includes a username and a password.

4. The method of claim 1, wherein the account identifier stored in the transaction database is encrypted.

5. The method of claim 1, wherein the client computer is operated by a resource providing entity.

6. The method of claim 1, wherein receiving the confirmation from the transaction processor computer occurs through an API call.

7. The method of claim 1, wherein the details for the transaction include a payment amount for the transaction.

8. The method of claim 1, wherein the method further comprises:
receiving, by the transaction guiding computer, a subsequent request from the client computer to process a subsequent transaction, wherein the subsequent request includes the reference to the transaction.

9. The method of claim 8, wherein the method further comprises:
retrieving, by the transaction guiding computer, the account identifier from the transaction database using the reference to the transaction.

10. The method of claim 9, wherein the account identifier is used to process the subsequent transaction.

11. A computer-implemented method comprising:
sending, by a client computer, a request to a transaction guiding computer to process a transaction through an existing online account managed by an authorizing entity;
receiving, by the client computer, instructions for a user of the client computer to supply a set of credentials to the authorizing entity, wherein the set of credentials is associated with the existing online account managed by the authorizing entity;
receiving, by the client computer, a confirmation from the transaction guiding computer indicating the supplied set of credentials is valid, wherein the confirmation further includes a reference to the transaction; and
storing, by the client computer, the reference to the transaction in a transaction reference database.

12. The method of claim 11, wherein the account identifier is an account number.

13. The method of claim 11, wherein the supplied set of credentials includes a username and a password.

14. The method of claim 1, wherein the client computer is operated by a resource providing entity.

15. The method of claim 11, wherein the method further comprises:
storing, by the client computer, an identifier for the user along with the reference to the transaction in the transaction reference database.

16. The method of claim 15, wherein the method further comprises:
receiving, by the client computer, an initiation of a subsequent transaction with the user.

17. The method of claim 16, wherein the method further comprises:
retrieving, by the client computer, the reference to the transaction from the transaction reference database using the identifier for the user.

18. The method of claim 17, wherein the method further comprises:
sending, by the client computer, a subsequent request to the transaction guiding computer to process the subsequent transaction, wherein the subsequent request includes the reference to the transaction.

19. A computer-implemented method comprising:
receiving, by a transaction guiding computer, a request from a client computer to refund a transaction processed through an existing online account managed by an authorizing entity, wherein the request includes a reference to the transaction and a refund amount;
retrieving, by the transaction guiding computer, an account identifier along with details for the transaction from a transaction databased based on the reference to the transaction, wherein the details for the transaction include a payment amount;
determining, by the transaction guiding computer, that the refund amount does not exceed the payment amount;
determining, by the transaction guiding computer, a transaction processor computer for refunding the transaction;
sending, by the transaction guiding computer, the refund request to the transaction processor computer along with the account identifier.

20. The method of claim 19, wherein the account identifier is an account number.
